(19) United States
(12) Patent Application Publication
(10) Pub. No.: US 2024/0319051 A1
(43) Pub. Date: Sep. 26, 2024

(54) SPECIMEN TREATMENT METHOD

(71) Applicant: TAIPEI VETERANS GENERAL HOSPITAL, TAIPEI (TW)

(72) Inventors: TAI-CHI LIN, TAIPEI (TW); LEI-CHI WANG, TAIPEI (TW)

(73) Assignee: TAIPEI VETERANS GENERAL HOSPITAL, TAIPEI (TW)

(21) Appl. No.: 18/407,238

(22) Filed: Jan. 8, 2024

(30) Foreign Application Priority Data
Mar. 22, 2023 (TW) 112110670

(51) Int. Cl. G01N 1/30; G01N 1/28; G01N 1/36

(52) U.S. Cl. CPC G01N 1/30; G01N 2001/2873; G01N 2001/305; G01N 2001/364; G01N 2001/368

(57) ABSTRACT

The present application provides a treatment method of a specimen from a biological tissue comprising: sandwiching the specimen into a carrier, placing a pad on an outside of the carrier, immersing the specimen with the carrier and the pad into a fixative solution, and embedding the specimen with the carrier and the pad, wherein the biological tissue is from an eye.

### BACKGROUND OF THE INVENTION

### 1. Field of the Invention

The present application relates to a method for treating a specimen from a biological tissue, and more particularly to a method for treating a specimen from retinal tissue in vitro.

### 2. Description of the Related Art

Pars plana vitrectomy with membrane peeling is a well-established procedure for treating diseases or conditions of the vitreomacular interfaces, including vitreomacular traction, retinoschisis, epiretinal membranes (ERMs) and macular holes (Duker et al., 2013).

The removed retinal membranes are used as the specimen. Conventionally, flat-mount preparations is applied to treat the removed retinal membranes. In flat-mount preparations, the whole membranes are laid on slides to provide enface images of the cellular composition of the specimen. To observe the specimen and determine the cell types in the specimen, optical microscope, fluorescence conjugate focal microscope, phase-contrast microscope or electron microscope can be used. Knott G et al., J Neurosci 2008, 28:2959-64; Bushby AJ. et al., Nat Protoc 2011, 6:845-58; Schmidt F. et al., Ultramicroscopy 2011, 111:259-66; Hirata A et al., Transl Vis Sci Technol 2018, 7:15.

This conventional specimen preparation of retinal membranes can be conducted easily and simply, but the final specimen is not shown as single-layered tissue having a thickness of about 5 μm because the retinal membrane has not been embedded and sectioned. Such plural layers of tissue in the final specimen cause overlapping cells in the field of view under microscope observation, making it impossible to determine and quantify cells precisely. Further, the applied apparatus such as fluorescence conjugate focal microscope or electron microscope are expensive and has higher requirements for operators, such that the flat-mount preparations is difficult to be used as a routine specimen processing method.

The specimen prepared by the flat-mount preparations is not at solid state with a certain thickness, and can be only treated with hematoxylin-eosin (H&E) stain, i.e. a single-time stain. Such specimen cannot be applied for further immunohistochemical examination because the tissue has not been embedded by an embedding agent such as paraffin and cannot be sectioned to form thin slices for immunohistochemical staining. Accordingly, the differentiation source of cells in the specimen prepared by the flat-mount preparations cannot be further determined.

Moreover, the biological tissues of specimens that have not been fixed and embedded will degenerate and degrade over time. Such specimens cannot be stored for a long time, not mention to be provided for follow-up examination and research.

According to the above, the tissues such as the retinal membranes are usually discarded after surgery, and cannot be used as a tissue source for research on human retinal diseases. The diseased tissue from the patient cannot be analyzed for prognosis and medical treatment. Therefore, there is still a need to develop methods for processing retinal specimens.

### SUMMARY

The present application describes a method for treating a specimen from a biological tissue comprising: sandwiching the specimen into a carrier, placing a pad on an outside of the carrier, immersing the specimen with the carrier and the pad into a fixative solution, and embedding the specimen with the carrier and the pad. The method is applied to treat the specimen in vitro.

### BRIEF DESCRIPTION OF THE DRAWINGS

FIG. 1 shows the workflow of the specimen treating method according to one embodiment of the present application.

FIG. 2 shows the H&E stained results of the conventional flat-mounted specimens and the formalin-fixed, paraffin embedded (FFPE) specimens of the present application for comparison. Scale bar: 50 μm.

FIG. 3 shows histological features and immunohistochemical findings of epiretinal membrane (ERM). Panel A shows that the H&E stain reveals a hypercellular membrane. Panel B shows that most of the cells are immunoreactive for GFAP, indicating their glial cells origin. Panel C shows some macrophage-like cells identified with CD68 stain. Panel D shows some myofibroblasts identified with SMA stain. Scale bar: 50 μm.

FIG. 4 shows histological features and immunohistochemical findings of internal limiting membrane (ILM). Panel A shows a hypocellular, homogenous membrane with H&E stain. Panel B shows glial cells demonstrated with GFAP stain. Panel C shows CD68-positive macrophage-like cells. Panel D shows absence of SMA-positive myofibroblasts. Scale bar: 40 μm.

FIG. 5 shows the ERM microenvironment of sectioned slides of sERM specimen obtained from a patient who previously received vitrectomy and silicon oil tamponade for retinal detachment 8 months ago. Panel A is the H&E stain showing numerous silicon oil droplets (arrows) and intraretinal spreading of melanin pigments derived from retinal pigment epithelial cells (asterisk). Panel B is GFAP stain showing active proliferation of glial cells. Panel C shows that the cells surrounding the silicon oil are macrophage origin through CD68 stain. Panel D shows only few myofibroblasts with SMA stain. Scale bar: 50 μm.

FIG. 6 shows subretinal bands mainly composed of glial cells and macrophage-like cells. The specimen is obtained from a patient with chronic retinal detachment. Panel A is H&E stain showing dense, eosinophilic, collagenous depositions in the specimen. Panel B shows some glial cells being outside the collagen with GFAP stain, wherein the number of glial cells is relatively lower than in other subretinal band specimens in this study. Panel C shows many macrophage-like cells within the collagenous membrane revealed by CD68 stain. Panel D shows absence of SMA-positive fibroblasts. Scale bar: 50 μm.

FIG. 7 shows that some of the cells in the membranes are “null-cells”. Panel A is H&E stain, Panel B is GFAP stain, Panel C: SMA stain, and Panel D is CD68 stain. Scale bar: 100 μm.

FIG. 8 shows various morphologies of glial cells in the same specimen of epiretinal membrane. Panel A shows that, at scanning power, a hypercellular membrane with glial-fibrillary background in some areas. Panel B shows the glial cells having small, round nuclei that resemble that of microglia. Panel C shows the glial cells having short spindle nuclei which are typically seen in the brain tissue. Panel D shows a few glial cells having large nuclei which have been described in Müller cells. (Panel A: H&E stain, scale bar: 100 μm; Panels B-D: left, H&E stain; right: GFAP stain, scale bar: 50 μm)

### DETAILED DESCRIPTION OF THE EMBODIMENTS

The present application provides a method for treating a specimen from a biological tissue comprising: sandwiching the specimen into a carrier, placing a pad on an outside of the carrier, immersing the specimen with the carrier and the pad into a fixative solution, and embedding the specimen with the carrier and the pad.

The method is applied to treat the specimen in vitro. In embodiments, the biological tissue is from a mammal, for example, but not limited to, rat, mouse, dog, cat, rabbit, human, monkey, and the like. In one embodiment, the biological tissue is from human.

In embodiments, the biological tissue is from an eye. For example, the biological tissue can be a retinal tissue. In one embodiment, the retinal tissue can be obtained by pars plana vitrectomy or macular surgery.

In the method of the present application, the specimen is sandwiched into a carrier. The carrier is made of filter materials, permeable materials, or a combination thereof. In one embodiment, the carrier can be a filter paper. In one embodiment, the specimen can be placed on the carrier, and the carrier is folded to cover the other side of the specimen. In one embodiment, the specimen can be placed on a first carrier, then a second carrier is placed on the specimen, the first carrier and the second carrier can be same or different carriers. In this step, a sandwich structure “carrier-specimen-carrier” is formed.

In some embodiments, the specimen of the biological tissue can be stained after the specimen is placed on the carrier. In some embodiments, the specimen is stained to locate the tissue if it is transparent. For example, hematoxylin stain can be applied on the specimen.

Next, a pad is wrapped on the outside of the carrier. The pad can be single pad or plural pads. If plural pads are applied, each pad can be of the same or different materials. Preferably, the pad does not directly contact with the specimen. In embodiments, after wrapping the pad, a structure “pad-carrier-specimen-carrier-pad” is formed. In embodiments, the pad can be made of absorbent materials, porous materials, soft materials, or a combination thereof, for example, but not limited to, sponges, resins and the like. In a preferred embodiment, the pad is a sponge pad.

The specimen is then immersed into a fixative solution. In some embodiments, the structure “pad-carrier-specimen-carrier-pad” is directly immersed into the fixative solution. In some embodiments, the specimen with the carrier and the pad are transferred into an embedding tissue cassette, and the embedding tissue cassette is immersed into the fixative solution. The fixative solution can be selected depending on the needs. The fixative solution can be, for example, but not limited to, formalin solutions such as the neutral formalin solution, alcohol/ethanol fixative solutions, Davidson's fixative solution, and the like. In one embodiment, the fixative solution is formalin solution.

After the immersion step, the embedding step is conducted. The embedding agent can be selected depending on the needs. In the embedding step, the specimen is treated with an embedding agent. The embedding agent can be, for example, but not limited to, paraffin, resin, agarose gel, collodion, carbowax, gelatin and the like. In one embodiment, the embedding agent is paraffin.

In some embodiments, the method further comprises: after the embedding step, slicing the specimen. The specimen embedded in paraffin can be sliced to form plural thin sheets with a thickness of about 5 μm.

Generally, the retinal tissue removed by surgery is a thin tissue with a small volume. It is difficult for the conventional specimen processed procedures of the retinal tissue to provide tissue sections or slices for further histological examinations. However, by applying the method of the present application, the retinal tissue can be covered by the carrier and the pad, such that the specimen of the obtained retinopathy tissue can be completely spread and flat, and does not move or be lost. Thereby, the specimen can be processed with the steps of fixing, dehydration, embedding, slicing and the like, and the specimen can be provided for the further pathological examination such as immunohistochemical staining. The specimen processed by the method of the present application can be stored permanently for subsequent research. Since the slicing step can be conducted, the specimen of the retinal tissue can be thin sheets, such that the cells in the specimen do not overlap and the cell characterization and cell counting can be conducted. The slice of the specimen can be digitized into digital whole slide images for permanent storage without fading problems.

Examples of method steps for treating the specimen obtained from biological tissue are further described hereafter.

To the best of the inventor's knowledge, this is the largest clinical study providing immunohistochemical data regarding retinal tissues. In contrast to other studies using confocal microscopy or electron microscopy, the FFPE method provided in the present application is efficient and economical and can be introduced into daily practice.

114 eyes of 114 patients with a clinical diagnosis of idiopathic ERMs (iERMs) (49/114, 43.0%), secondary ERMs (sERMs) (23/114, 20.2%), retinal detachment (13/114, 11.4%), macular holes (13/114, 11.4%), macular hole retinal detachment (3/114, 2.6%), proliferative diabetic retinopathy (5/114, 4.4%), myopic schisis (5/114, 2.6%), foveoschisis (1/114, 9.1%), vitreomacular traction (1/114, 9.1%), and endophthalmitis (1/114, 9.1%) were included in this study. The clinical characteristics of the patients are presented in Table 1.

TABLE 1
Characteristics of patients

| | Mean age | | Gender | Number of |
|---|---|---|---|---|
| Clinical Diagnosis | (Range) | | (Male:Female) | patients |
| iERM | 65.6 | (30-85) | 22:27 | 49 |
| sERM | 60 | (30-78) | 13:10 | 23 |
| Retinal detachment | 55.2 | (22-66) | 10:3 | 13 |
| Macular hole | 62.6 | (53-71) | 4:9 | 13 |
| Macular hole | 73.3 | (57-85) | 1:2 | 3 |
| retinal detachment | | | | |
| Proliferative | 49 | (32-71) | 1:4 | 5 |
| diabetic retinopathy | | | | |
| Myopic schisis | 58.8 | (35-85) | 3:2 | 5 |

| | | | |
|---|---|---|---|
| Foveoschisis | 73 | 0:1 | 1 |
| Vitreomacular traction | 88 | 1:0 | 1 |
| Endophthalmitis | 66 | 1:0 | 1 |

In total, 150 specimens were collected during the study period via pars plana vitrectomy or macular surgery. These specimens were labeled by vitreoretinal surgeons as ERMs (94/150, 62.67%), ILMs (39/150, 26%), subretinal bands (5/150, 3.33%), proliferative vitreoretinopathy (PVR) membranes (5/150, 3.33%), and posterior hyaloid membranes (PHMs) (7/150, 4.67%). For some patients, two specimens were submitted separately: ERM and ILM.

### Comparative Example

Of the 150 specimens, 52 specimens were prepared using the conventional method involving flat mounting on a slide. In brief, the removed tissues were immediately placed on glass slides as whole-mount membranes to view their maximum area and were then immersed in a fixative solution of 10% neutral formalin for at least 6 hours (h). Subsequently, the slides were air-dried at 70° C. and stained with hematoxylin and eosin (H&E).

### Example

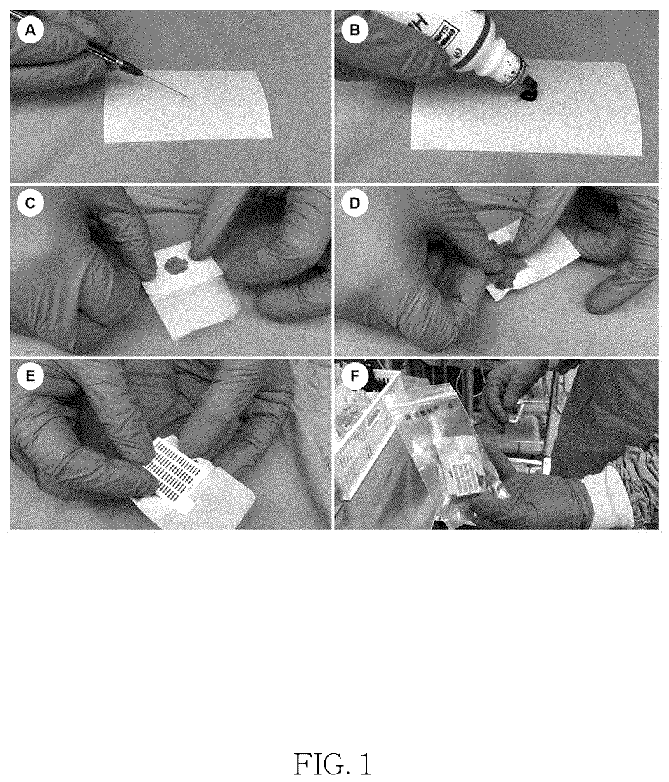

The other 98 specimens were prepared using the method of the present application (sometimes called “FFPE method” or “FFPE specimen”). Referring FIG. 1, the steps of the method are described as follows.

After peeling off the membrane, a surgeon flat mounted the membrane on a filter paper (FIG. 1, panel A), stained the area with hematoxylin (FIG. 1, panel B), and then folded the filter paper (FIG. 1, panel C) and placed it between two pieces of biopsy foam pads like a sandwich (FIG. 1, panel D). The “tissue sandwich” was then placed in the processing cassette used in the general surgical pathology laboratory (FIG. 1, panel E). The cassette with the specimen was immediately immersed in 10% neutral formalin and sent to the pathology laboratory (FIG. 1, panel F).

In the pathology department, a pathologist and technician examined the tissue under a dissecting microscope (SMZ 800 N, Nikon, Japan) and picked up the tissue using McPherson Tying Forceps Straight (PMS GmbH, Tuttlingen, Germany). These specimens underwent the tissue processing process, including dehydration, paraffin embedding, and sectioning. When the paraffin-embedded specimens were sectioned for the first time, in addition to preparing one blank slide for H&E staining, three positively charged blank slides were prepared for further immunostaining with antibodies against glial fibrillary acidic protein (GFAP) (1:300 dilution, clone 6F2, Dako, Denmark), smooth muscle actin (SMA) (1:100 dilution, clone 1A4, Dako, Denmark), and CD68 (1:50 dilution, clone PG-M1, Dako, Denmark). All immunohistochemical analyses were performed using a BOND-MAX autostainer (Leica Microsystem, Wetzlar, Germany) under the recommended heat induced epitope retrieval conditions and a BOND Polymer Refine Red Detection kit.

### Image Acquisition and Analysis

All the specimens were evaluated through light microscopy. Whole slide images of the 4 μm thin sections obtained from the formalin fixated, paraffin-embedded (FFPE) specimens were also scanned with a Philips Ultra Fast Scanner 1.8 (Philips IntelliSite Pathology Solution 3.2, Philips, The Netherlands). The images were acquired using Philips Image Management System 3.3 (Philips IntelliSite Pathology Solution 3.2, Philips, The Netherlands). For specimens that could not be scanned because of their small size, images were acquired using a Nikon Eclipse 80i microscope (Nikon, Japan) equipped with a Nikon DS-Fi3 camera (Nikon, Japan).

Only the specimens in which clear histological features could be examined under a microscope were defined as adequate specimens for histopathological examination. For these adequate specimens, the cellularity of glial cells, macrophage-like cells (including hyalocytes in the vitreous body and microglia in the retina), and myofibroblasts was calculated under a 40× objective lens (one high-power field). Given the limited size of most specimens, only one representative high-power field was selected for analysis. Cellularity was categorized into absent, low, medium, and high if the number of cells was 0, less than 10, 10-20, and more than 20, respectively, in one high-power field. For the remaining less predominant cell types, including retinal pigment epithelial (RPE) cells and inflammatory cells, cellularity was subjectively documented as absent, few, or many based on the evaluation of the entire specimen.

### Statistical Analysis

### Specimen Adequacy

The adequacy ratio of the conventional flat-mount method and the FFPE method of the present application was calculated as the total number of adequate specimens divided by the total number of submitted cases. Fisher's exact test was used to determine whether the FFPE method would affect specimen adequacy.

### Predominant Cell Types According to Specimen Types

After the adequacy of the specimens was assessed, only adequate cases were included for analyzing the cellular composition. The predominant cell types in different types of specimens labeled by retinal surgeons were analyzed using Pearson's chi-squared test. Multiple pairwise comparisons between specimen types were performed using Scheffe's post hoc test.

### Predominant Cell Types According to Disease Type

The predominant cell types in different disease subsets were also assessed. ILM specimens were subcategorized into ILMs associated with iERMs, macular holes, and sERMs. Likewise, sERM specimens were subcategorized into sERM developed in eyes with retinal detachment and those developed in eyes with diabetic retinopathy. Similarly, Pearson's chi-squared test and Scheffe's post hoc test were performed to determine whether the cellular composition significantly differed among the disease subsets. Statistical analysis was performed using IBM SPSS Statistics for Windows, version 26 (IBM Corp., Armonk, N.Y., USA). A two-tailed p value of 0.05 was considered statistically significant in all analyses.

### Results

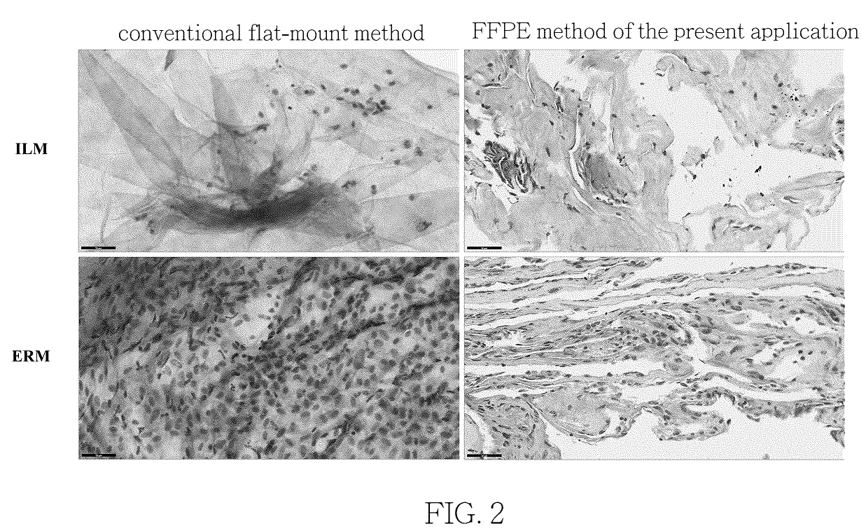

Image qualities obtained using the conventional flat-mount method and the FFPE method of the present application were compared through H&E staining, as shown in FIG. 2. The flat-mounted specimens have unavoidable folding artifacts, whereas the sectioned slides of FFPE specimens could produce well-focused photos without overlapping cell nuclei. Obviously, the image quality of a specimen prepared by the FFPE method was superior to that by the flat-mount method. The adequacy ratio of the flat-mount and FFPE methods was 86.5% (45/52) and 75.51% (74/98), respectively, and the difference was nonsignificant (p=0.1397).

Furthermore, the specimen adequacy ratio was compared among specimen types. The adequacy ratio for all types of specimens is shown in Table 2.

TABLE 2
Specimen types and their adequacy ratio of the flat-mount and FFPE methods

| Specimen types | | Adequacy ratio | | |
|---|---|---|---|---|
| labeled by | Flat-mount method | of flat-mount | FFPE method | Adequacy ratio |
| surgeons | (Adequate:Inadequate) | method | (Adequate:Inadequate) | of FFPE method |
| Epiretinal membrane | 20:3 | 86.96% | 58:13 | 81.69%* |
| Internal limiting membrane | 18:2 | 90% | 12:7 | 63.16%* |
| Subretinal band | 0:0 | n/a | 3:2 | 60% |
| PVR membrane | 1:2 | 33.33% | 1:1 | 50% |
| PHM membrane | 6:0 | 100% | 0:1 | 0% |

n/a = not available;
*p > 0.05, Fisher's exact test

For specimens labeled as ERMs, FFPE method had considerably high adequacy, which was comparable to that of the flat mount method (81.69% versus 86.96%, p=0.7530). For ILM specimens, the difference of the adequacy between the FFPE method and the flat mount method was nonsignificant (63.16% versus 90%, p=0.0648).

These results indicated that the FFPE method of the present application could be applied to most retinal specimens. Specimens with larger sizes, such as ERMs, were usually adequate for tissue embedding and sectioning.

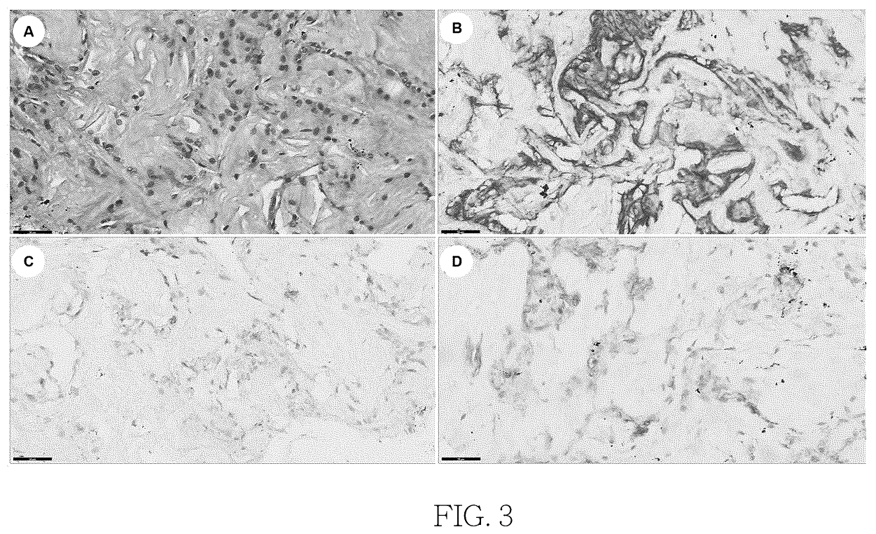

FIG. 3 to FIG. 6 further confirmed that the FFPE specimens could be provided for immunohistochemical analysis to clearly demonstrate the cell types and tissue microenvironment:

Observation of the sectioned ERM slide under a light microscope revealed a hypercellular membrane (FIG. 3, panel A). The cells predominantly consisted of glial cells (FIG. 3, panel B), with the occasionally presence of macrophage-like cells, including hyalocytes from the vitreous body and microglia from the retina (FIG. 3, panel C), and myofibroblasts (FIG. 3, panel D). The lineage of the cells could be demonstrated with immunohistochemical analysis of GFAP, CD68, and SMA.

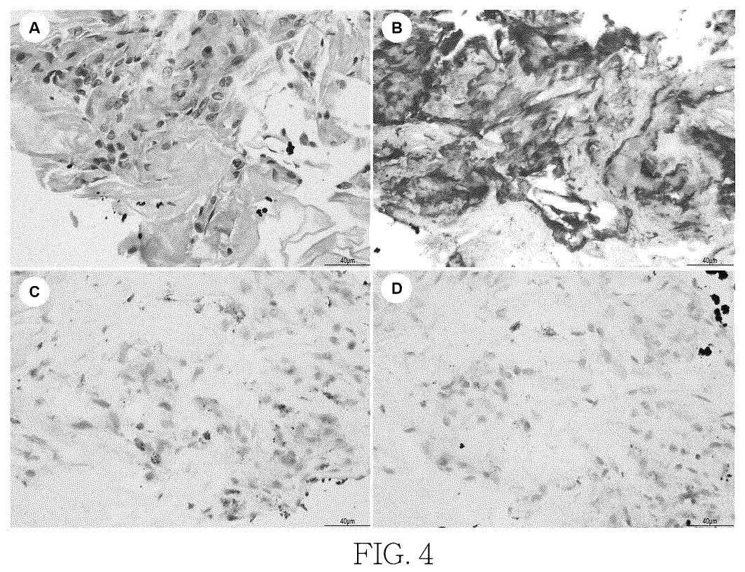

Observation of the sectioned ILM slide revealed a hypocellular to moderately cellular homogenous membrane (FIG. 4, panel A), with few glial cells (FIG. 4, panel B). Macrophage-like cells (FIG. 4, panel C) and myofibroblasts (FIG. 4, panel D) were rarely detected.

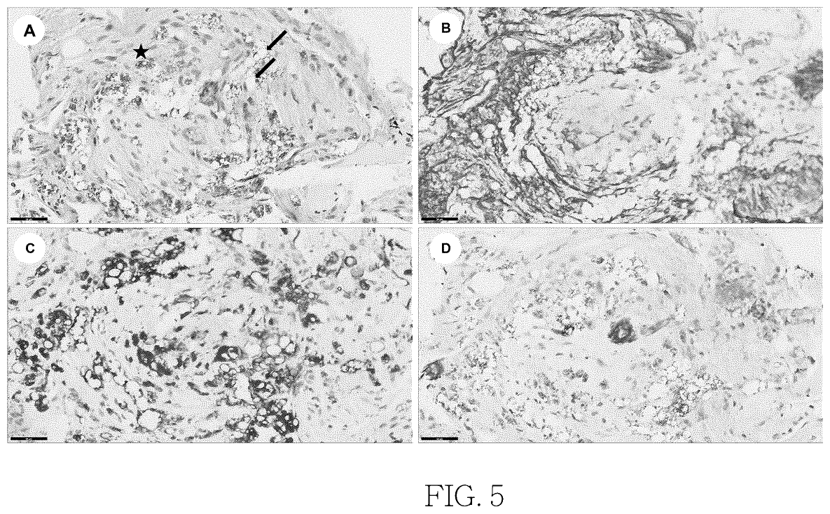

In FIG. 5, this specimen is a secondary epiretinal membrane (sERMs) from a patient who previously received vitrectomy and silicon oil tamponade for retinal detachment 8 months ago. sERMs removed from silicon oil-filled eyes were found to be rich in macrophage-like cells and glial cells. Residual silicon oil droplets could be easily detected within the membrane (FIG. 5, panels A-D).

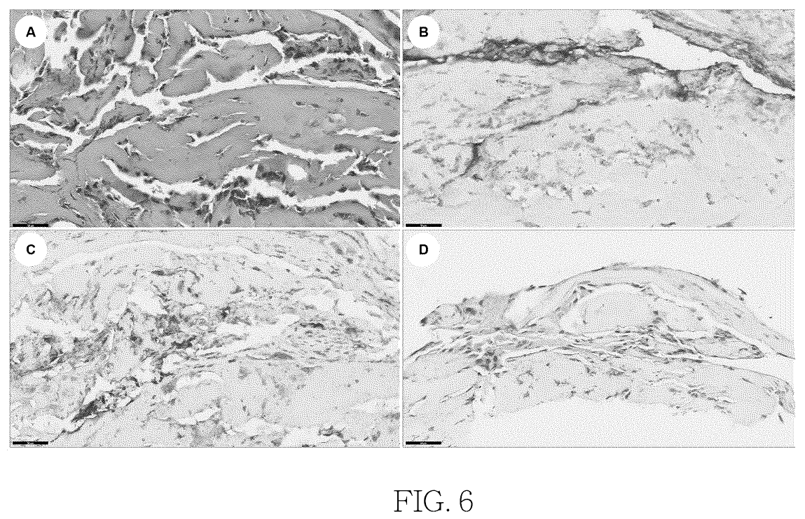

In FIG. 6, this is a subretinal band excised from a patient with chronic retinal detachment. Despite the small number of specimens, it was found that all the specimens labeled as subretinal bands predominantly consisted of glial cells or macrophage-like cells instead of myofibroblasts (FIG. 6, panels A-D).

The Predominant Cell Types in Different Specimen Types and Disease Processes could be Analyzed Using the FFPE Specimens:

After inadequate specimens were excluded, 119 specimens were identified as having available data regarding the cellularity of glial cells, macrophage-like cells, myofibroblasts, RPE cells, and inflammatory cells. These included iERM (n=51), ILM (n=30), sERM (n=27), PHM (n=6), PVR (n=2), and subretinal band (n=3) specimens. The PHM, PVR, and subretinal band specimens were excluded from statistical analysis because of the small sample size.

Among the iERM, ILM, and sERM specimens, a significant difference was noted in the cellularity of glial cells, macrophage-like cells, myofibroblasts, and RPE cells, as shown in Table 3. These cells were mainly detected in specimens labeled as iERMs and sERMs. Inflammatory cells were rarely detected in all types of specimens; thus, the difference was nonsignificant (p=0.122).

TABLE 3
Analysis of predominant cell types in different specimen types

| | | | | p-value for the |
|---|---|---|---|---|
| | | | | Pearson's chi- |
| Cell types | iERM | ILM | sERM | squared test |
| Glial cells | | | | 0.000 |
| absent | 0 | 1 | 1 | |
| low | 18 | 22 | 2 | |
| medium | 4 | 3 | 3 | |
| high | 29 | 4 | 21 | |
| Myofibroblasts | | | | 0.012 |
| absent | 31 | 26 | 11 | |
| low | 13 | 4 | 12 | |
| medium | 3 | 0 | 3 | |
| high | 4 | 0 | 1 | |
| Macrophage-like cells | | | | 0.000 |
| absent | 22 | 22 | 3 | |
| low | 20 | 7 | 11 | |
| medium | 6 | 0 | 7 | |
| high | 3 | 1 | 6 | |
| RPE cells | | | | 0.001 |
| absent | 49 | 28 | 18 | |
| few | 1 | 1 | 2 | |
| many | 1 | 1 | 7 | |
| Pigments | | | | 0.000 |
| absent | 44 | 30 | 6 | |
| few | 4 | 0 | 9 | |
| many | 3 | 0 | 12 | |
| Inflammatory cells | | | | 0.122 |
| absent | 50 | 30 | 24 | |
| few | 1 | 0 | 2 | |
| many | 0 | 0 | 1 | |

Each pair of groups was further compared by using Scheffe's post hoc test. The results revealed that the number of glial cells and myofibroblasts was significantly lower in the ILM group than in the iERM or sERM group. Although the density of glial cells and myofibroblasts did not differ between the iERM and sERM groups, the sERM group had a significantly higher number of macrophage-like cells and RPE cells than the iERM group, as shown in Table 4.

TABLE 4
Pairwise comparison using Scheffe's post hoc test

| Pairwise comparison of cell types | Significance |
|---|---|
| Glial cells | |
| iERM vs ILM | 0.000 |
| ILM vs sERM | 0.000 |
| iERM vs sERM | 0.134 |
| Myofibroblasts | |
| iERM vs ILM | 0.031 |
| ILM vs sERM | 0.009 |
| iERM vs sERM | 0.652 |
| Macrophage-like cells | |
| iERM vs ILM | 0.058 |
| ILM vs sERM | 0.000 |
| iERM vs sERM | 0.001 |
| RPE cells | |
| iERM vs ILM | 0.946 |
| ILM vs sERM | 0.003 |
| iERM vs sERM | 0.000 |

Moreover, a subgroup analysis of ILMs and sERMs was performed according to different clinical diagnoses. The ILM specimens were subcategorized into ILMs peeled off from eyes with iERMs (n=15), macular holes (n=5), and sERMs (n=6). No significant difference was noted in the cellular composition within and between the groups. Similarly, sERM specimens were subcategorized into sERMs acquired from eyes with retinal detachment (n=19) and diabetic retinopathy (n=8). No significant difference was noted in the cellular composition between the two groups; however, a larger amount of melanin pigments was observed in sERM acquired from eyes with retinal detachment (p=0.016).

The FFPE Specimens of the Present Application could be Permanently Preserved for Future Research:

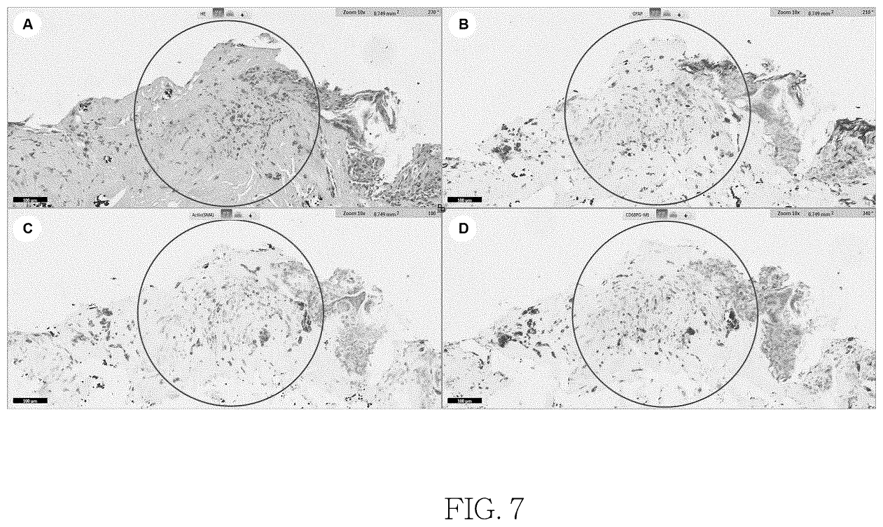

In some specimens of sERM arising from retinal detachment, some of the ovoid to short spindle cells in the circle area could not be determined by staining GFAP, CD68, or SMA (FIG. 7, panels A-D), indicating that these “null-cells” have no evidence of specific cell lineage differentiation demonstrated by immunohistochemistry for common cell origins. These “null cells” had cytological features indistinguishable from those of glial cells, macrophage-like cells, or myofibroblasts, and the nature of these cells requires further investigation.

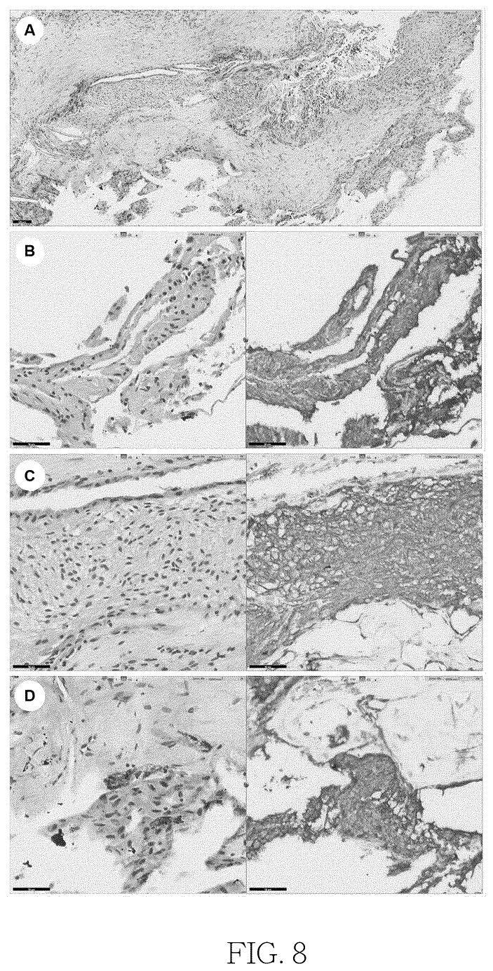

Moreover, it was observed that the morphology of GFAP-positive cells, namely glial cells, ranged from small, round, microglialike to short spindle or large cells with vesicular nuclei, as shown in FIG. 8, panels A-D. The latter two morphologies (short spindle or large cells) have been observed in Müller cells in previous studies. Without immunohistochemical findings, differentiating glial cells from myofibroblasts or macrophage-like cells based on histology alone would be difficult because of their overlapping histological features. By applying the FFPE method of the present application, the obtained specimens were applied for immunohistochemical analysis and could be permanently preserved for future research.

The present application provides a feasible method for treating and examining epiretinal and subretinal tissues, which can be conducted in general pathology laboratories. Compared with the flat-mount method, the FFPE method provided excellent preservation of the retinal tissues and reduced folding artifacts. In particular, the FFPE specimens can be further sliced to form slices with a thickness of about 5 μm. Since the diameter of general cells, e.g. 7 μm of red blood cell, is larger than 5 μm of thickness of the FFPE specimen slice, the cells within the slice do not overlap with each other. The FFPE specimen slice can be scanned by a digital scanning machine to produce a digital pathology slide, which provides a clear image and can be applied for quantitative cell counting. The digital pathology slide can be permanently preserved without discoloration. Moreover, the specimen applicability can be maintained while the more excellent image quality is provided by the FFPE specimen. According to the above, the FFPE method of the present application is effective and economical, and can be introduced into the routine examination procedure.

Through immunohistochemical analysis of the FFPE specimens of the present application, the differences in the cellular composition of iERMs, sERMs, and ILMs are demonstrated, providing novel information on the etiology of diseases that occur as a result of adhesion in the vitreomacular interface. With the advent of the novel tissue processing technologies of the present application (i.e. FFPE method) and imaging modalities, the three-dimensional microenvironment and relevant biomarkers of retinal diseases can be developed in the future, thereby helping vitreoretinal specialists to perform outcome prognostication and establish potential therapeutic strategies.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims and its equivalent systems and methods.

What is claimed is:

1. A method for treating a specimen from a biological tissue comprising:
sandwiching the specimen into a carrier,
placing a pad on an outside of the carrier,
immersing the specimen with the carrier and the pad into a fixative solution, and embedding the specimen with the carrier and the pad,
wherein the biological tissue is from an eye.

2. The method of claim 1, wherein the specimen is from a retinal tissue.

3. The method of claim 1, wherein the retina is obtained by pars plana vitrectomy and/or macular surgery.

4. The method of claim 1, wherein the carrier comprises a filter paper.

5. The method of claim 1, wherein the pad comprises a sponge pad.

6. The method of claim 1, wherein the fixative solution comprises formalin solution, ethanol fixative solution and/or Davidson's fixative solution.

7. The method of claim 1, wherein in the embedding step, the specimen is treated with paraffin, resin, agarose gel, collodion, carbowax and/or gelatin.

8. The method of claim 1, further comprising: after the embedding step, slicing the specimen.

9. The method of claim 1, wherein the immersing step further comprises: transferring the specimen with the carrier and the pad into an embedding tissue cassette, and immersing the embedding tissue cassette into a fixative solution.

10. The method of claim 1, further comprising: staining the specimen of the biological tissue.
